(19) United States
(12) Patent Application Publication
(10) Pub. No.: US 2006/0089759 A1
(43) Pub. Date: Apr. 27, 2006

(54) SYSTEMS AND METHODS FOR PERFORMING HIGH ACCURATE DISTANCE MEASURING FOR RADAR ALTIMETERS

(75) Inventor: Robert C. Becker, Eden Prairie, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 10/906,288

(22) Filed: Feb. 11, 2005

Related U.S. Application Data
(60) Provisional application No. 60/621,588, filed on Oct. 22, 2004.

(51) Int. Cl. G01C 23/00

(52) U.S. Cl. 701/3; 701/4

(57) ABSTRACT

Systems and methods for measuring aircraft altitude less than 10 meters. Two signals having different frequencies are simultaneously transmitted. Returns or echos of the two signals are received. The phase of the return of the first and second signals are determined. A distance value based on the determined phase of the first and second return signals is determined.

### CROSS-REFERENCE TO RELATED APPLICATIONS

This application claims the benefit of U.S. Provisional Application Ser. No. 60/621,588, filed Oct. 22, 2004, which is hereby incorporated by reference.

### BACKGROUND OF THE INVENTION

Commercial aircraft exhibit their highest take-off fuel efficiency when departing the ground most rapidly. Rapid ground departure escapes ground effect drag quickly and improves fuel economy. However, the possibility of striking the aircraft tail on the ground if the angle of attack is too steep exists. If the distance between the tail and the ground could be accurately measured, the flight controls could limit the angle of attack automatically to prevent tail strikes as well as provide the peripheral benefit of improved take-off fuel efficiency.

Presently, Frequency Modulation, Continuous Wave (FMCW) radar altimeters require frequency sweep rates of >1 GHz to measure distance to within an accuracy of ˜2″. This is an impractical implementation for a radar altimeter as well as illegal, as the bandwidth of such a transmitter would exceed the allowable frequency allocation for radar altimeters. However, there exists a need for accuracy of ˜2″ without the complexity or the high cost. Therefore, there exists a need for more accurate close range radar altimeters for use in applications, such as tail strike warning system.

### BRIEF SUMMARY OF THE INVENTION

Embodiments of the present invention include systems and methods for measuring aircraft altitude when the aircraft is less than 10 meters above ground level. Two modulating signals having different frequencies are simultaneously transmitted. Returns or echos of the composite signal are received. The phase of the return of the first modulating and second modulating signals are determined. A distance value based on the determined phase of the first and second return modulations is determined.

### BRIEF DESCRIPTION OF THE SEVERAL VIEWS OF THE DRAWING

The preferred and alternative embodiments of the present invention are described in detail below with reference to the following drawings.

FIG. 1 illustrates an exemplary system formed in accordance with an embodiment of the present invention;

FIG. 2 illustrates a flow diagram illustrating an exemplary process performed by the system shown in FIG. 1; and

FIGS. 3 and 4 illustrate two signals outputted by the system of FIG. 1 for use by that system in determining distance.

### DETAILED DESCRIPTION OF THE INVENTION

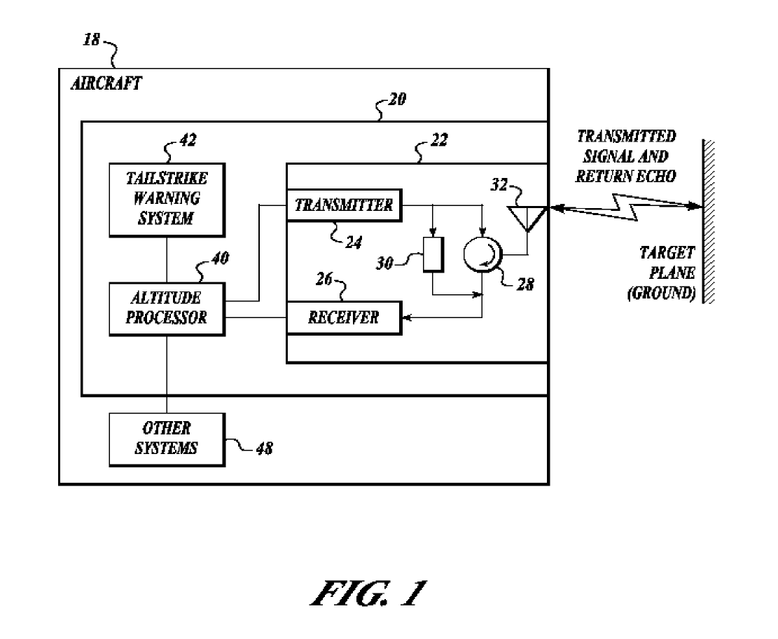

FIG. 1 illustrates an example system 20 that generates highly accurate low range distance calculations in an aircraft 18. In one embodiment, the system 20 includes a radar altimeter 22, an altitude processor 40, and a tail strike warning system 42. The radar altimeter 22 includes a transmitter 24, a receiver 26, and a circulator 28, nulling circuitry 30, and an antenna 32. The altitude processor 40 is in signal communication with the transmitter 24 and the receiver 26. The tail strike warning system 42 is in signal communication with the altitude processor 40.

The circulator 28 is configured to direct signals generated by the transmitter 24 to the antenna 32 and to direct signals received by the antenna 32 to the receiver 26. The nulling circuit 30 provides additional isolation of the receiver 26 from the transmitter 24 by reducing the level of the transmitter signal present in the receiver beyond the isolation provided by the circulator 28.

The altitude processor 40 receives radar return signals from the receiver 26 and determines a distance value based on the signals received from the receiver 26. The distance value is sent to the tail strike warning system 42. The tail strike warning system 42 activates an alert if the distance value is below a threshold amount. The distance value may be sent to other aircraft systems 48, such as a navigation or flight management system. The navigation or flight management system may command flight controls in order to maximize climb angle and protect against over-rotation and attendant tail strikes.

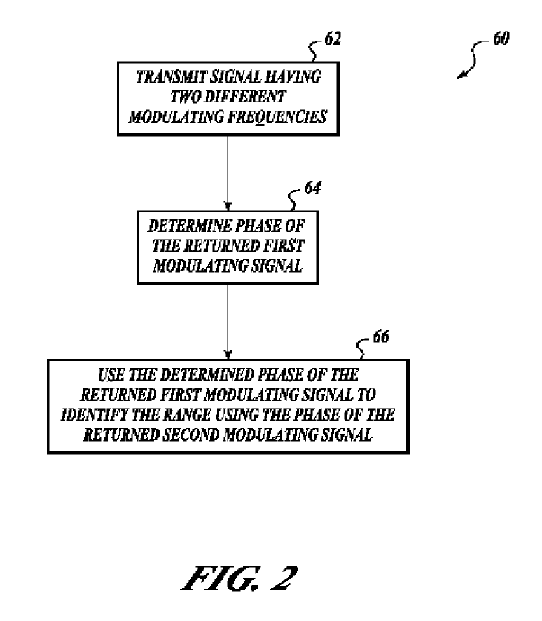

FIG. 2 illustrates a flow diagram of an example process 60 performed by the system 20 shown in FIG. 1. First, at a block 62, a signal having two different modulating frequencies is transmitted via the antenna 32. The radar return of the transmitted signal is sent to the altitude processor 40. The altitude processor 40 determines the phase of the returned first modulation, see block 64. At a block 66, the altitude processor 40 uses the determined phase of the first modulation (modulating signal) to identify a range value using the returned second modulating signal. In this embodiment, the first modulation has a lower frequency than the second modulation (modulating signal). Because the first modulation has a lower frequency, the return of the first modulating signal is used to roughly determine a distance value or determine a phase location that is used when analyzing the return second modulating signal. Because the second signal is a higher frequency than the first signal, it is more accurate for determining the distance value.

The present invention measures coarse distance using a low frequency amplitude modulated signal and resolves this to highly accurate value using a second higher frequency amplitude modulated signal. Range accuracy is dependent on the accuracy of the phase measurement.

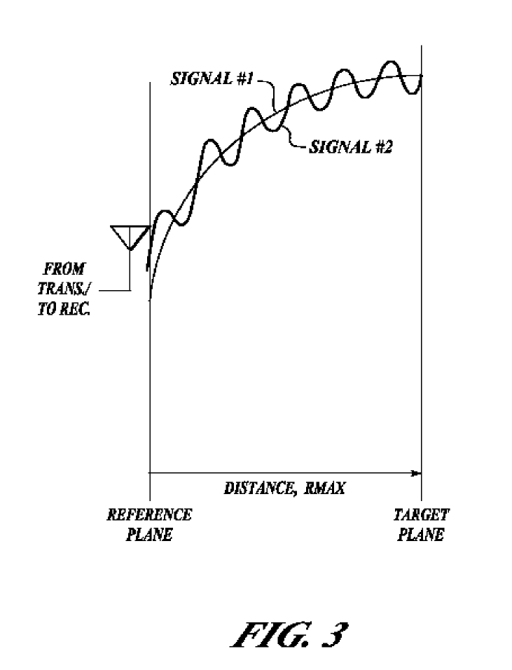

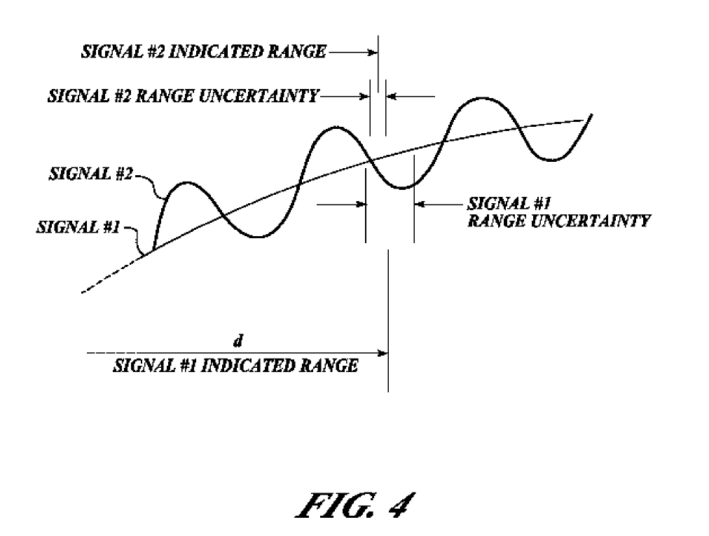

Range accuracy improves by the ratio of the frequency of the primary signal to the frequency of the secondary signal, provided the secondary frequency is not so much higher than the primary frequency that range error of the primary frequency exceeds the wavelength of the secondary frequency minus the range accuracy of the secondary frequency, see FIGS. 3 and 4.

The phase angle can be measured only up to 360° without ambiguity and the accuracy of the phase measurement is the same for all modulation frequencies. Converting from wavelength, λ₁, to frequency using c=f*λ₁, where c=speed of light, f₁₍ₘₐₓ₎<8*c/λ₁, or f₁₍ₘₐₓ₎<8*c/Rₘₐₓ.

Because the phase angle can be accurately measured to 360° without ambiguity, the maximum useful range is 2*Rₘₐₓ<λ₁, which makes fₘₐₓ<2*c/Rₘₐₓ. However, if the phase of the first modulating frequency is allowed to approach 360°, it is possible that a return of greater than 360° may be received and this would be undetectable without additional measures, such as a third modulating frequency. To prevent this from occurring, it may be advantageous to design the receiver to have insufficient sensitivity to detect a signal returned from a distance corresponding to greater than 90°. For this example, twice the maximum useful range, 2*Rₘₐₓ, is limited to <λ₁/4, or a 90° phase difference. Therefore, Rₘₐₓ<λ₁/8, or λ₁>8*Rₘₐₓ.

With regard to range accuracy, if the accuracy of the phase angle measurement is limited to ±x₁°, range accuracy uncertainty is dx₁=λ₁*x₁/360. Thus, we know the coarse range only to within a distance of ±dx₁. In order to use amplitude modulation signal #2 to resolve fine range, the wavelength of signal #2 must be longer than the range uncertainty from modulating frequency f₁ of the first signal.
Therefore, λ₂>2*λ₁*x₁/360, or
f₂<f₁*360/(2*i x₁)

However, the phase angle of modulating frequency f₂ can be measured only to some limited accuracy, ±x₂°. Therefore, the frequency f₂ of signal #2 must be decreased by a factor of (360−x₂)/360.

Thus,
f2′=f2*((320−x₂)/360)=((360−x₂)/360)*f₁*360/(2*x₁)=((360−x₂)*f₁/(2*x₁)

Where f2′ is the corrected secondary range measurement frequency.

The ultimate range accuracy is dx₂=λ₂*x₂/360.

Depending on the required accuracy of the range measurements, one is free to choose frequencies lower than the ones calculated.

While the preferred embodiment of the invention has been illustrated and described, as noted above, many changes can be made without departing from the spirit and scope of the invention. For example, other radar altimeter configurations may be used, such as a dual antenna radar altimeter. Another example is a radar altimeter configuration using three or more modulating frequencies. Accordingly, the scope of the invention is not limited by the disclosure of the preferred embodiment. Instead, the invention should be determined entirely by reference to the claims that follow here.

What is claimed is:

1. A method performed on an aircraft, the method comprising:
simultaneously transmitting a signal having different two or more modulating frequencies;
receiving returns of the signal with two modulating frequencies;
determining the phase of the return of the first modulating signal;
determining the phase of the returned second modulating signal; and
determining a distance value based on the determined phase of the first and second return modulating signals.

2. The method of claim 1, further comprising:
determining if the determined distance value is less than a threshold value; and
if the distance value is determined to be less than the threshold value, generating a tail strike warning signal.

3. The method of claim 2, further comprising:
generating at least one of an audio or visual alert, if a tail strike warning signal has been generated.

4. The method of claim 1, further comprising:
controlling aircraft flight operation based on the determined distance value.

5. The method of claim 1, further comprising:
outputting aircraft flight operation control instructions based on the determined distance value.

6. The method of claim 1, wherein the first and second signals are amplitude modulated.

7. The method of claim 6, wherein the wavelength of the first signal is greater than or equal to a predetermined maximum distance range value.

8. The method of claim 7, wherein the wavelength of the second signal is greater than a range uncertainty value for the first signal.

9. The method of claim 8, wherein f₂<f₁*360/(2*x₁), f₂ is frequency of the second signal, f₁ is frequency of the first signal, and x₁ is a predefined accuracy value of the phase angle measurement for the first signal.

10. An aircraft system comprising:
a transmitter configured to generate a signal having two or more different modulating frequencies;
an antenna configured to simultaneously transmit the generated signals and receive returns of the transmitted signals;
a receiver configured to process the received returns; and
a processing component configured to determine the phase of the return of the first signal modulating, determine the phase of the returned second modulating signal, and determine a distance value based on the determined phase of the first and second return modulating signals.

11. The system of claim 10, further comprising:
a warning component configured to determine if the determined distance value is less than a threshold value, and if the distance value is determined to be less than the threshold value, generating a tail strike warning signal.

12. The system of claim 11, wherein the warning component further is configured to generate at least one of an audio or visual alert, if a tail strike warning signal has been generated.

13. The system of claim 10, further comprising:
a component configured to control aircraft flight operation based on the determined distance value.

14. The system of claim 10, further comprising:
one or more interface devices configured to output aircraft flight operation control instructions based on the determined distance value.

15. The system of claim 10, wherein the first and second signals are amplitude modulated.

16. The system of claim 15, wherein the wavelength of the first signal is greater than or equal to a predetermined maximum distance range value.

17. The system of claim 16, wherein the wavelength of the second signal is greater than a range uncertainty value for the first signal.

18. The system of claim 17, wherein f₂<f₁*360/(2*x₁), f₂ is frequency of the second signal, f₁ is frequency of the first signal, and x₁ is a predefined accuracy value of the phase angle measurement for the first signal.
